(19) United States
(12) Patent Application Publication
(10) Pub. No.: US 2015/0227452 A1
(43) Pub. Date: Aug. 13, 2015

(54) SYSTEM AND METHOD FOR TESTING SOFTWARE APPLICATIONS

(71) Applicant: Wipro Limited, Bangalore (IN)

(72) Inventors: Girish Raghavan, Chennai (IN); Imtiyaz Ahmed Shaikh, Mumbai (IN); Ganesh Narayan, Bangalore (IN)

(73) Assignee: Wipro Limited, Bangalore (IN)

(21) Appl. No.: 14/228,311

(22) Filed: Mar. 28, 2014

(30) Foreign Application Priority Data
Feb. 12, 2014 (IN) 658/CHE/2014

(51) Int. Cl. G06F 11/36

(52) U.S. Cl. CPC G06F 11/3684; G06F 11/3676; G06F 11/3688

(57) ABSTRACT

Systems and methods of testing, of software applications, based on business process models are described herein. In one example, the method comprises receiving, by a processor, the at least one business process model, wherein the at least one business process model is indicative of a business process associated with the software application and analyzing, by the processor, the at least one business process model to identify at least one test scenario. The method further comprises generating, by the processor, a set of test cases and test data for the at least one test scenario and producing, by the processor, a set of test automation scripts based on one or more keywords associated with the at least one test scenario.

### RELATED APPLICATIONS

This application claims the benefit of Indian Patent Application Filing No. 658/CHE/2014, filed Feb. 12, 2014, which is hereby incorporated by reference in its entirety.

### FIELD OF THE INVENTION

The present subject matter relates to testing of software applications, and, particularly but not exclusively, to testing, of software applications, based on business process models.

### BACKGROUND OF THE INVENTION

Testing of software applications is an important phase in the lifecycle of the software applications. Most software development organizations rely on their software application testing prowess for their efficiency and profitability. In recent times, there is an increasing trend to develop modular and large integrated software applications which has increased the complexity of testing software applications. For example, software applications may have to be tested to ensure that the software applications are supported on different hardware and software configurations and meet various stringent quality requirements. The software applications may also have to be tested to ensure that the software applications conform to the business processes of the software organizations or of the client for whom the software applications have been developed.

With time, the business processes, based on which the software applications have been developed, may undergo changes to address varying business requirements. Thus, the software applications may also have to be updated accordingly. Therefore, the software applications have to be tested to ensure that the changes in the business processes have been incorporated. The software applications may also be tested to ensure that the components of the software applications, unaffected by the changes in the business processes, are functional and have not broken down due to changes made in the other components of the software applications.

Developing test cases for testing software applications is a tedious and time consuming activity which is very susceptible to errors due to various reasons including misinterpretation of requirements of the software applications. Often the test cases do not cover the full scope of the requirements due to which the final version of the software applications may still include bugs, i.e., errors, flaws, or faults which causes the software applications to produce erroneous or unexpected results. This results in dissatisfaction of the clients which may spoil the reputation of the software organization and may cause loss of potential business opportunities.

### SUMMARY OF THE INVENTION

Disclosed herein are systems and methods for testing, of software applications, based on business process models. In one example, the system for testing, of software applications, based on business process models comprise a processor, a memory executable by the processor. The system further comprises a data input module, executable by the processor, to receive the at least one business process model from a user, wherein the at least one business process model is indicative of at least one business process associated with the software application; and a test scenario identification module, executable by the processor, to analyze the at least one business process model to identify at least one test scenario. In one example, the system also includes a test case generation module, executable by the processor, to generate a set of test cases and test data for the at least one test scenario; and a test script generation module, executable by the processor, to produce a set of test automation scripts based on one or more keywords associated with the at least one test scenario.

In an aspect of the invention, the method for testing, of software applications, based on business process models comprise receiving, by a processor, the at least one business process model, wherein the at least one business process model is indicative of at least business process associated with the software application and analyzing, by the processor, the at least one business process model to identify at least one test scenario. The method further comprises generating, by the processor, a set of test cases and test data for the at least one test scenario; and producing, by the processor, a set of test automation scripts based on one or more keywords associated with the at least one test scenario.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a network environment implementing a software application testing system for testing, of software applications, based on business process models, according to some embodiments of the present subject matter.

FIG. 2 illustrates an exemplary computer method for identifying test scenarios from business process models so as to test of software applications based on business process models, according to some embodiments of the present subject matter.

FIG. 3 illustrates an exemplary computer implemented method for generating test cases for testing, of software applications, based on business process models, according to some embodiments of the present subject matter.

FIG. 4 illustrates an exemplary method incorporating changes in business process models for testing, of software applications, based on business process models, according to some embodiments of the present subject matter.

FIG. 5 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods for testing, of software applications, based on business process models are described. The systems and methods may be implemented in a variety of computing systems. The computing systems that can implement the described method(s) include, but are not limited to a server, a desktop personal computer, a notebook or a portable computer, a mainframe computer, and a mobile computing environment. Although the description herein is with reference to certain computing systems, the systems and methods may be implemented in other computing systems, albeit with a few variations, as will be understood by a person skilled in the art.

Conventionally, testing of software applications is a tedious and error-prone process. In many cases, the requirements of the software applications change rapidly with time. Hence, the test cases for testing the software applications also have to be updated accordingly. For example, software applications which are developed in accordance with Agile methodology, a group of software development methods based on iterative and incremental development, where requirements and solutions evolve through collaboration between self-organizing, cross-functional teams, the test cases have to be updated at frequent time intervals. This increases the time spent on updating the test suit and also makes the testing process prone to errors.

Further, in many cases, the requirements of the software applications may not have been captured correctly. For example, a difference in understanding of the business analysts who understand the requirements of the software from the client(s), the software development team who develops the software applications, and the testing team who test the software applications, usually lead to misrepresentation of the requirements of the software application which results in the software application not functioning as expected. Moreover, due to constraints of time and resources it is difficult to develop test cases which cover the full scope of the requirements. This usually results in some bugs being present in the final version of the software product.

In situations, where a manual test suite is developed for testing the software applications, the test suite has to be associated with test data and test parameters for every step. Thus, with time, the number of test parameters and volume of test data increases which becomes very tedious to manage. Further, whenever the business processes are updated, the test suite also has to be updated with new test cases, test data and test parameters. This makes managing the test suite difficult.

The conventional methods and systems for testing software applications do not address the aforementioned issues which typically results in a time consuming, resource intensive and error-prone processes of testing software applications. Hence, in many cases, the final version of the software applications include multiple bugs which may result in dissatisfaction of the clients, spoil the reputation of the software organization and cause loss of potential business opportunities.

The present subject matter discloses systems and methods for testing, of software applications, based on business process models. In one example, the term “business process” may include any process which may be represented by state transition diagrams and which may involve one or more action(s) that are capable of being performed manually as well as one or more action(s) that are capable of being executed by a computing system. The term “business process” may also include any type of process that may be performed by any enterprise or organization to carry out its functions, such as sales, administration, billing and manufacturing. The business process model may include any informal and/or formal description(s) to represent core aspects of a business carried out by an enterprise or an organization, including purpose, offerings, strategies, infrastructure, organizational structures, trading practices, and operational processes and policies.

In one implementation, the method of testing, of software applications, based on business process models comprise analyzing a business process model and identifying test scenarios from the analyzed business process model. Thereafter, one or more set(s) of test cases along with its associated test data and test parameters is generated for each of the identified test scenarios. In one implementation, the set of test cases, for each of the identified test scenarios, may be optimized. Thereafter, keyword driven pseudo automated test scripts are generated for executing the test cases.

Thus, the present subject matter analyses business process models to identify general requirements and rules, which covers the business processes to identify test scenarios. These test scenarios help in examining the functioning of the software applications as implementations of the business processes. The tests may also be used under a specific hardware-software deployment and constraints of resources to generate detailed test data, test parameters and test scripts. Thus, the methods described in the present subject matter analyze the business process models and the conformity of the software applications with the business process models and scripts rather than the structure of the software application itself, in terms of its source code and modules.

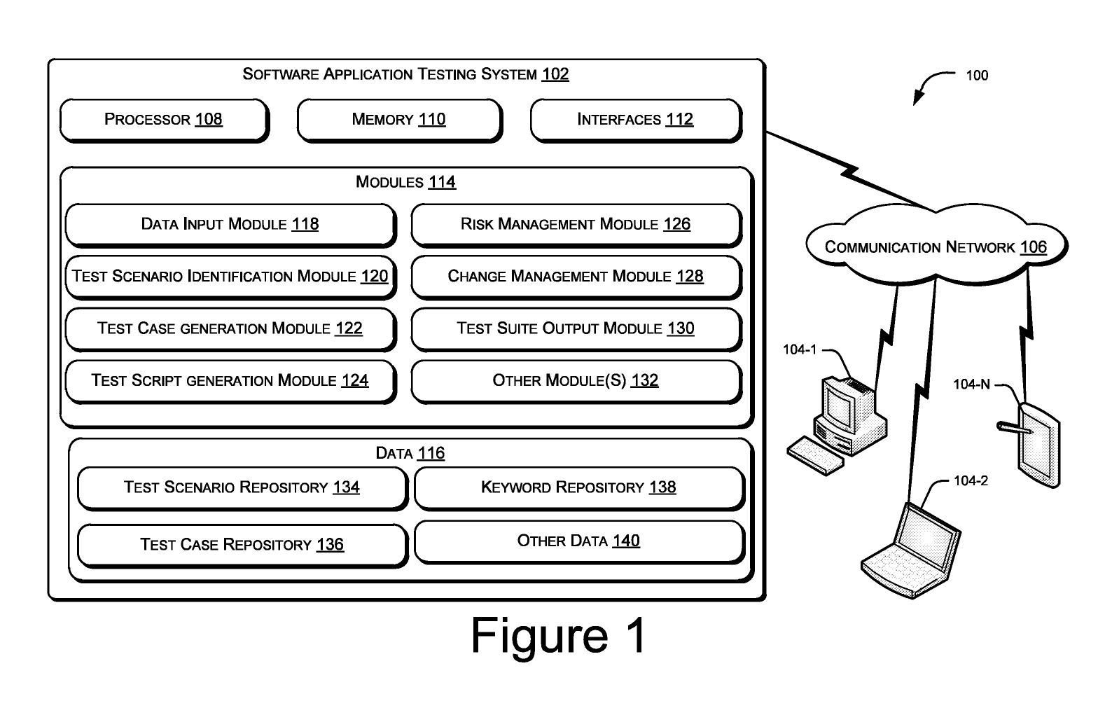

The working of the systems and methods of testing, of software applications, based on business process models is described in greater detail in conjunction with FIG. 1-5. It should be note that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a network environment 100 implementing a software application testing system 102, henceforth referred to as the SAT system 102, according to some embodiments of the present subject matter. In said embodiment, the network environment 100 includes the SAT system 102 configured for testing, of software applications, based on business process models. In one implementation, the SAT system 102 may be included within an existing information technology infrastructure of an organization. For example, the SAT system 102 may be interfaced with the existing content and document management system(s), database and file management system(s), of the organization.

The SAT system 102 may be implemented in a variety of computing systems, such as a laptop computer, a desktop computer, a notebook, a workstation, a mainframe computer, a server, a network server, and the like. It will be understood that the SAT system 102 may be accessed by users through one or more client devices 104-1, 104-2, 104-3 . . . 104-N, collectively referred to as client devices 104. Examples of the client devices 104 include, but are not limited to, a desktop computer, a portable computer, a mobile phone, a handheld device, a workstation. The client devices 104 may be used by various stakeholders or end users of software application testing in the organizations such as developers, testers and system administrators. As shown in the figure, such client devices 104 are communicatively coupled to the SAT system 102 through a network 106 for facilitating one or more end users to access and operate the SAT system 102.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc.

In one implementation, the SAT system 102 includes a processor 108, a memory 110 coupled to the processor 108 and interfaces 112. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions stored in the memory 110. The memory 110 can include any non-transitory computer-readable medium known in the art including, for example, volatile memory (e.g., RAM), and/or non-volatile memory (e.g., EPROM, flash memory, etc.).

The interface(s) 112 may include a variety of software and hardware interfaces, for example, a web interface, a graphical user interface, etc., allowing the SAT system 102 to interact with the client devices 104. Further, the interface(s) 112 may enable the SAT system 102 to communicate with other computing devices, The interface(s) 112 can facilitate multiple communications within a wide variety of networks and protocol types, including wired networks, for example LAN, cable, etc., and wireless networks such as WLAN, cellular, or satellite. The interface(s) 112 may include one or more ports for connecting a number of devices to each other or to another server.

In one example, the SAT system 102 includes modules 114 and data 116. In one embodiment, the modules 114 and the data 116 may be stored within the memory 110. In one example, the modules 114, amongst other things, include routines, programs, objects, components, and data structures, which perform particular tasks or implement particular abstract data types. The modules 114 may also be implemented as, signal processor(s), state machine(s), logic circuitries, and/or any other device or component that manipulate signals based on operational instructions. Further, the modules 114 can be implemented by one or more hardware components, by computer-readable instructions executed by a processing unit, or by a combination thereof.

In one implementation, the modules 114 further include a data input module 118, a test scenario identification module 120, a test cases generation module 122, a test scripts generation module 124, a risk management module 126, a change management module 128, a test suite output module 130 and other modules 132. The other modules 132 may perform various miscellaneous functionalities of the SAT system 102. It will be appreciated that such aforementioned modules may be represented as a single module or a combination of different modules.

In one example, the data 116 serves, amongst other things, as a repository for storing data fetched, processed, received and generated by one or more of the modules 114. In one implementation, the data 116 may include, for example, test scenarios repository 134, test cases repository 136, keywords repository 138, and other data 140. In one embodiment, the data 116 may be stored in the memory 110 in the form of various data structures. Additionally, the aforementioned data can be organized using data models, such as relational or hierarchical data models. The other data 140 may be used to store data, including temporary data and temporary files, generated by the modules 114 for performing the various functions of the SAT system 102.

In operation, the data input module 118 receives various details regarding the software application which is to be tested. In one example, the data input module 118 may generate various interfaces to facilitate a user to provide one or more business process models associated with the software application as an input to the SAT system 102. The business process models may include various system design representation of the software application. In one example, the business process models may be in the form of flow diagrams which have been generated using various commercially available diagramming and vector graphics application. In one example, the data input module 118 may include various application programming interfaces (APIs) which facilitate the user to directly import the business process models from various diagramming and vector graphics applications to the SAT system 102. In another example, the data input module 118 may facilitate the user to import business process models from Extensible Markup Language (XML) Process Definition Language (XPDL) based applications. In one example, the data input module 118 may also store the business process models in the data 116 for future use or modification.

In one example, the data input module 118 may also facilitate the user to provide various test conditions for testing the software application. The test conditions may be understood to be a combination of business conditions and the expected outcomes of every operation in the business process model on the occurrence of the aforementioned business conditions. In one example, the data input module 118, based on user input and/or predefined rules, map the test conditions with the corresponding operations in the business process models.

In one example, the data input module 118 may also prompt the user to provide various test parameters for testing the software application. The test parameters may be understood to be placeholders or variables for storing data values which define the flow of process in the business process model.

The data input module 118 also receives user requirements for the software application being tested. In one example, the identifiers for requirements may be provided as an input by the user or may be directly imported by the user from various requirement tool databases and linked to test scenarios. For example, the user may provide customer specific business processes modelled in form of a state diagram, Unified Modeling Language (UML) diagram and so on which may be created with various commercially available software tools. The user may also use the data input module 118 to provide risk parameters which are indicative of the criticality of one or more operations in the business process model. For example, the risk parameters may indicate one or more operations to have different levels of criticality, such as high, medium, and low, based on the impact of the one or more operations on the nature of the business. In one example, the risk parameters are forwarded to the test scenarios identification module 120 for further processing.

In one example, the data input module 118 also receives changed values from the user, wherein the changed values are indicative of changes to one or more operations in the business processes associated with the software application. In one example, the changed values may be routed to the test scenario identification module 120 and the test cases generation module 122 for updating the test scenarios and test cases respectively.

Thereafter, the test scenario identification module 120 analyzes the business process models received by the data input module 118 and parses the same to identify various test case scenarios. In one example, the test scenario identification module 120 identifies the various unique paths in business process models, wherein each path corresponds to a different way in which the business process may be implemented or carried out. Each of these unique paths corresponds to a test scenario. In other words, a business process may comprise multiple test scenarios and each test scenario may comprise multiple operations.

In one example, the test scenario identification module 120 may parse the business process models and represent the identified test scenarios in a business process diagram (BPD) format. The BPD format facilitates the readability and comprehensibility of the representation of the software application and helps the user in understanding the requirements of the software application. This reduces errors caused due to misinterpretation of requirements. The test scenario identification module 120 also maps the test conditions and test parameters, received from the user by the data input module 118, with the operations present in each of the test scenarios. Post-mapping, the test scenario identification module 120 concatenates the test conditions of each operation and the test parameters associated with each operation to generate the test scenarios. In one example, the test scenario identification module 120 may store the generated test scenarios in the test scenario repository 134.

Thereafter, the test case generation module 122 receives the test scenarios from the test scenario identification module 120 or retrieves the test scenarios from the test scenarios repository 134 for further processing. In one example, the test case generation module 122 binds the parameters present in the test scenarios with the test data provided received from the user through the data input module 118. Generally, a test scenario may have multiple data configurations. In other words, each of the test scenarios identified from the business process models may have multiple test cases with each test case being associated with a different set of test data. Herein, each unique data combination of test data which is used to generate a test case from a test scenario is defined as the test configuration.

In one example, the test case generation module 122 may be communicatively coupled with a third party test data optimizer so as to select the optimal set of test configurations based on optimized sets of test data generated by the third party test data optimizer. In said example, the test case generation module 122 maps the optimal set of test configurations with the respective test scenarios. Thereafter, the test case generation module 122 concatenates the set of test data with the parameters or placeholders in the test scenarios to generate test cases. In one example, the test case generation module 122 stores the generated test cases in the test case repository 136.

In parallel to the operations of the test case generation module 122, the test script generation module 124 processes the test scenarios to generate the test automation scripts. In one example, the test script generation module 124 is communicatively coupled with the keyword repository 138. The keyword repository 138 stores various keywords which correspond to pre-built procedures that enable creation of test automation scripts across multiple tools and technologies. For example, there can be diverse keywords depending on the action to be executed, such as ‘click’ to signify clicking in an abject, ‘input’ to signify inputting of text and ‘verify’ to indicate verification of a provided value with pre-defined rules. In one example, the user may update the keywords repository 138 to include additional keywords so as to support multiple automation tools so that the test script generation module 124 generates test automation scripts in a tool agnostic way so as to enable the usage of the test automation scripts across multiple automation tools without any modifications. In one example, the test script generation module 124 receives the manual test steps provided by the user as test script reader values through the data input module 118. In one example, the test script reader value comprises a text description and its corresponding expected result value. The test script generation module 124 identifies the corresponding keywords, for each of the test script reader values, from the keyword repository 138. The keyword identified for each test script reader value corresponds to a set of pseudo keyword steps for the manual test steps. These keywords are delinked from the actual tool used for automation thus facilitating its usage with any automation framework. Based on the identified keywords, the test script generation module 124 generates the test automation scripts. In one example, the test script generation module 124 may also facilitate the user to manually select the keywords associated with the manual steps of the testing process.

In another example, the test script generation module 124 retrieves the test scenarios which have to automated and parses the same. The test script generation module 124 analyzes the parsed test scenarios to match the manual steps in the testing process of the test scenarios with a keyword from the keyword repository 138. Based on the mapping the test script generation module 124 generates the test automation scripts for testing the software application.

In one example, the test scenarios may also be processed by a risk management module 126 to associate a risk index with each of the test scenarios wherein the risk index is indicative of the criticality and the priority of the test scenario. In one example, the risk management module 126 assigns the risk index with the test scenarios based on the business criticality of the test scenario and the risk factor associated with the test scenario. In one example, the user may provide a risk rating, such as high, medium, and low, for each of the business process. Based on the risk rating provided by the user, the risk management module 126 ascertains the risk rating of the test scenarios of the business process as one of complete, high, medium or low.

In one example, if the risk rating is complete, the risk management module 126 instructs the test scenario identification module 120 and the test case generation module 122 to convert all path flows of the business processes into test cases without performing any optimization.

In another example, if the risk rating is high, the risk management module 126 instructs the test scenario identification module 120 and the test case generation module 122 to include all business processes which have a high rating and their child processes in the test cases. Additionally the risk management module 126 instructs the test scenario identification module 120 and the test case generation module 122 to include at least one path having low and/or medium risk ratings. The persons skilled in the art may also come up with various other combinations or techniques for analyzing risk associated with the business processes which may be implemented by the risk management module 126.

In one scenario, the test suite output module 130 generates the test cases and the test scripts in a user-defined template. The test suite output module 130 may also be communicatively coupled with various test management tools using APIs to upload the test cases and test scripts to the test management tools. In one example, the test suite output module 130 fetches the generated test cases from the test case repository 136 and maps the test cases to pre-defined fields or place holders in the user-defined template. The test suite output module 130 also generates the test automation scripts, which are keyword based, in form of a file which may be in various formats, such as text and spreadsheets. The test suite output module 130 may upload the test automation scripts to the carious test management tools as an attachment. This facilitates the test management tools to run the tests as per schedule.

As mentioned earlier, with time the business processes associated with the software application may be updated and the user may upload the business process models, corresponding to the updated business process, using the data input module 118. Thereafter, the change management module 128 determines the impact of the changes made in the business process models. In one example, the change management module 128 parses the updated business model and compares it with the parsed version of the previous business model so as to generate a comparative snapshot of the impact analysis. The comparative snapshot may identify or highlight the test scenarios that have added, modified and deleted in the new business process model. Based on the comparative snapshot, the change management module 128 updates the test scenarios stored in the test scenario repository 134, and maps the new requirements and change values to the respective new and/or modified test scenarios.

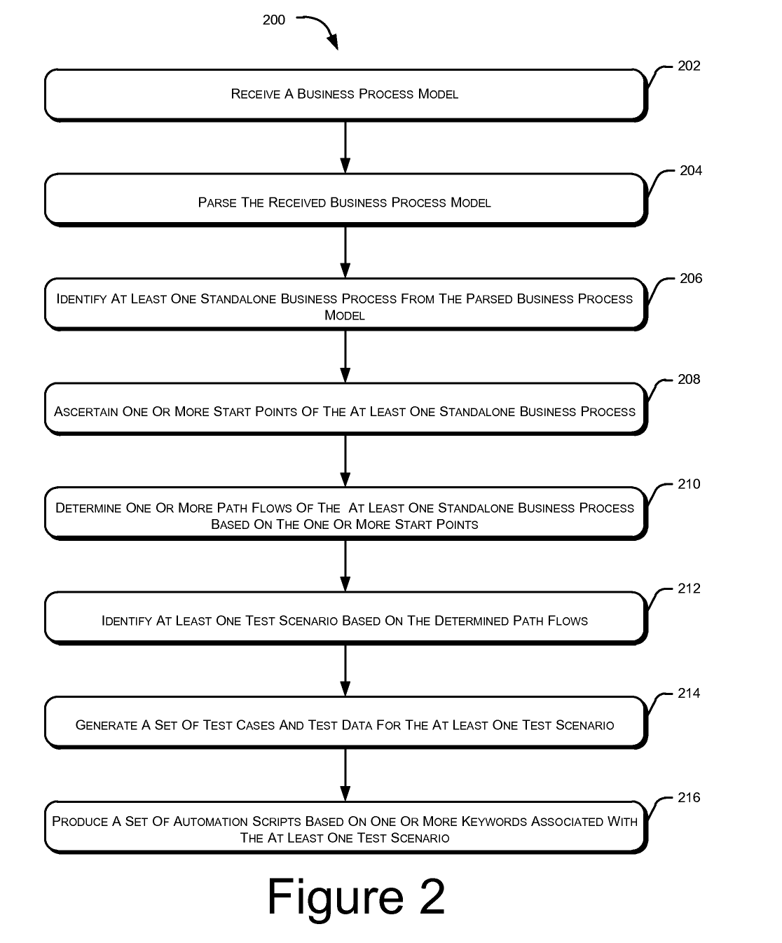

Thus, the SAT system 102 analyses business process models to identify general requirements and rules, which covers the business processes to identify test scenarios. Hence, the SAT system 102 examines or tests the functioning of the software applications as implementations of the business processes. The SAT system 102 also analyzes the conformity of the software applications with the business process models and scripts rather than the structure of the software application itself, in terms of its source code and modules. The detailed working of the SAT system 102 is further explained in conjunction with the FIGS. 2-5.

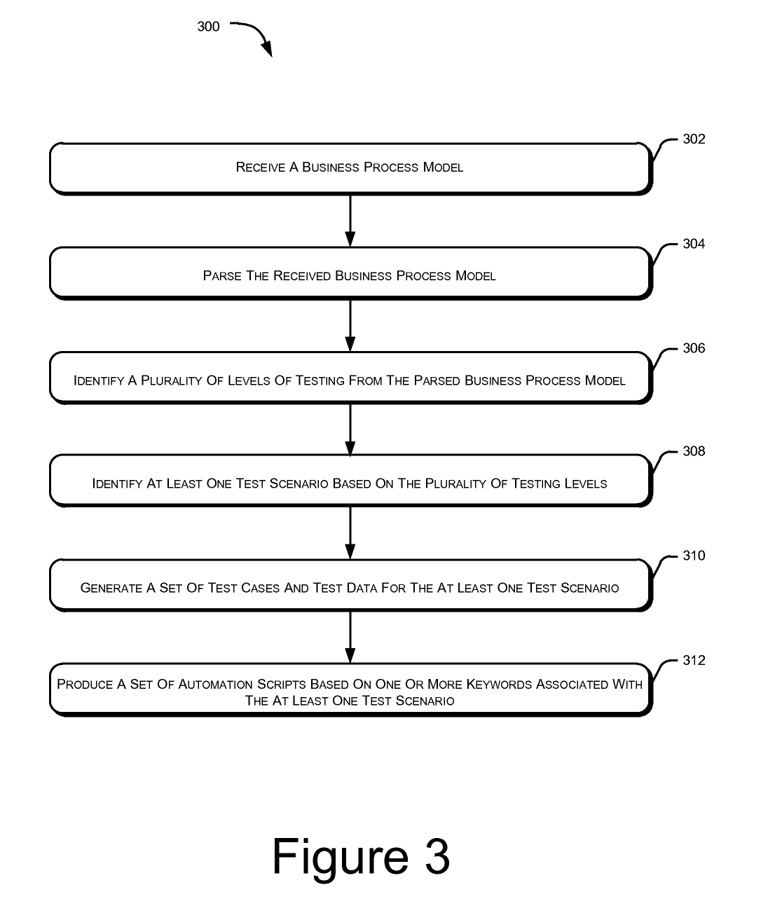

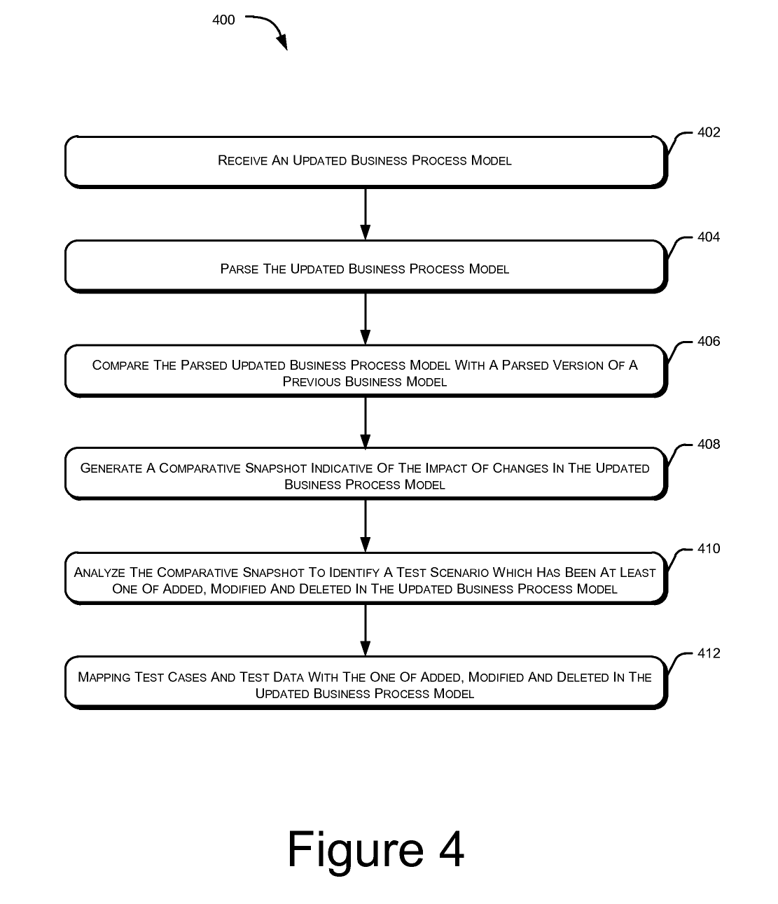

FIG. 2 illustrates an exemplary computer method 200 for identifying test scenarios from business process models so as to testing, of software applications, based on business process models, according to some embodiments of the present subject matter. FIG. 3 illustrates an exemplary computer implemented method 300 for generating test cases for testing, of software applications, based on business process models, according to some embodiments of the present subject matter. FIG. 4 illustrates an exemplary method 400 incorporating changes in business process models for testing, of software applications, based on business process models, according to some embodiments of the present subject matter. The methods 200, 300, and 400 may be described in the general context of computer executable instructions. Generally, computer executable instructions can include routines, programs, objects, components, data structures, procedures, modules, and functions, which perform particular functions or implement particular abstract data types. The methods 200, 300, and 400 may also be practiced in a distributed computing environment where functions are performed by remote processing devices that are linked through a communication network. In a distributed computing environment, computer executable instructions may be located in both local and remote computer storage media, including memory storage devices.

The order in which the methods 200, 300, and 400 is described is not intended to be construed as a limitation, and any number of the described method blocks can be combined in any order to implement the methods 200, 300, and 400 or alternative methods. Additionally, individual blocks may be deleted from the methods 200, 300, and 400 without departing from the spirit and scope of the subject matter described herein. Furthermore, the methods 200, 300, and 400 can be implemented in any suitable hardware, software, firmware, or combination thereof.

With reference to method 200 as depicted in FIG. 2, as shown in block 202, a business process model is received. In one example, the data input module 118 may generate various interfaces or may be communicatively coupled with various commercially used APIs to facilitate the user to upload the business process models indicative of the business process(es) associated with the software application to be tested.

As depicted in block 204, the received business process model is parsed. In one implementation, the test scenario identification module 120 parses the business process models received from the user.

As illustrated in block 206, at least one standalone business process is identified from the parsed business process model. In said implementation, the test scenario identification module 120 identification module one or more standalone business process(es) represented in the business process model.

At block 208 one or more start points, of the at least one standalone business process, is ascertained. In one example, the test scenario identification module 120 identifies one or more probable starting points of the identified standalone business process(es). For example, some business process may cater to multiple types of consumer or a customer may initiate a process for multiple reasons or in multiple scenarios. In such cases, the identified standalone business process(es) may have a plurality of start points which may be identified by the test scenario identification module 120.

As shown in block 210, one or more path flows of the at least one standalone business process is determined based on the one or more start points. In one example, the test scenario identification module 120 identifies the possible path flows of the identified standalone business process(es) based on the probable start points of the identified standalone business process(es).

As depicted in block 212, at least one test scenario is identified based on the determined path flows. In one example, the test scenario identification module 120 identifies the test scenarios in the identified standalone business process(es) based on the possible path flows of the identified standalone business process(es).

As illustrated in block 214, a set of test cases and test data is generated for the at least one test scenario. In one example, the test case generation module 122 generates the set of test cases and test data for each of the identified test scenarios. As would be understood by a person skilled in the art, each of identified test scenarios may be associated with multiple test cases.

At block 216, a set of test automation scripts is produced based on one or more keywords associated with the at least one test scenario. In one example, the test script generation module 124 generates the set of test automation scripts for executing the test cases generated by the test case generation module 122.

With reference to method 300 as depicted in FIG. 3, at block 302 a business process model is received. In one example, the data input module 118 may generate various interfaces or may be communicatively coupled with various commercially used APIs to facilitate the user to upload the business process models indicative of the business process(es) associated with the software application to be tested.

As depicted in block 304, the received business process model is parsed. In one implementation, the test scenario identification module 120 parses the business process models received from the user.

As illustrated in block 306, a plurality of levels of testing is identified from the parsed business process model. In one example, the test scenario identification module 120 may identify the various levels of testing from the business process model. As is known to persons skilled in the art, the tests are generally grouped by the level of specificity of the test. For example, the Software Engineering Body of Knowledge (SWEBOK) states that the main levels of testing are unit testing, integration testing, and system testing. The tests are distinguished by the test target without implying any specific business process.

As shown in block 308, at least one test scenario is identified based on the plurality of testing levels. In one example, based on the level of testing, the test scenarios are identified by the test scenario identification module 120. For example, in unit testing, the test scenarios may be identified so as to verify the functionality of a specific section of code, usually at the function level. In another example, for integration testing, test scenarios to verify the interfaces between components of the software application, against the design of the software application, may be identified.

At block 310, a set of test cases and test data is generated for the at least one test scenario′ In one example, the test case generation module 122 generates the set of test cases and test data for each of the identified test scenarios. As mentioned earlier, each of identified test scenarios may be associated with multiple test cases.

As depicted in block 312, a set of automation scripts is produced based on one or more keywords associated with the at least one test scenario. In one example, the test script generation module 124 generates the set of test automation scripts for executing the test cases generated by the test case generation module 122.

With reference to method 400 as depicted in FIG. 4, as shown in block 402, an updated business process model is received. In one example, the change management module 128 may generate various interfaces or may be communicatively coupled with various commercially used APIs to facilitate the user to upload the updated business process models indicative of the changes in the business process(es) associated with the software application to be tested. The change management module 128 may also facilitate the user to update the existing business process models to indicate the changes in the business process(es) associated with the software application to be tested

At block 404, the updated business process model is parsed. In one example, the change management module 128 parses the updated business process model.

As illustrated in block 406, the parsed updated business process model with a parsed version of a previous business model is compared. In one example, the change management module 128 compares the parsed updated business process model with the parsed version of an existing business process model.

At block 408, a comparative snapshot is generated, wherein the comparative snapshot is indicative of the impact of changes in the updated business process model. In one example, the change management module 128 generates a comparative snapshot indicative of the differences between the updated business process model and the existing business process model.

As illustrated in block 410, the comparative snapshot is analyzed to identify a test scenario which has been at least one of added, modified and deleted in the updated business process model. In one example, the change management module 128 analyzes the updated business process model which has been at least one of added, modified and deleted in the updated business process model. For example, the test scenarios which are relevant for both the existing business process model and the updated business process model and hence, may not have to be modified may be highlighted in a specific color, say green, by the change management module 128.

In another example, the test scenarios of the existing business process model partially map onto the test scenarios of the updated business process model may be highlighted in a different color, say amber, by the change management module 128. In one example, the change management module 128 may denote a partial map whenever one or more business processes are missing in the existing business process model. In one implementation, the change management module 128 may prompt the user for an input to indicate a partial map between the test scenarios of the existing business process model and the updated business process model.

In yet another example, the change management module 128 may detect the test scenarios which are completely new and are relevant only for the updated business process model. Thereafter, the change management module 128 may also update the test scenario repository 134 with the new test scenarios.

As depicted in block 412, test cases and test data are mapped with the one of added, modified and deleted in the updated business process model. In one example, the test case generation module 122 generates the set of test cases and test data for the new test scenarios. Each of the new test scenarios may be associated with multiple test cases.

### Computer System

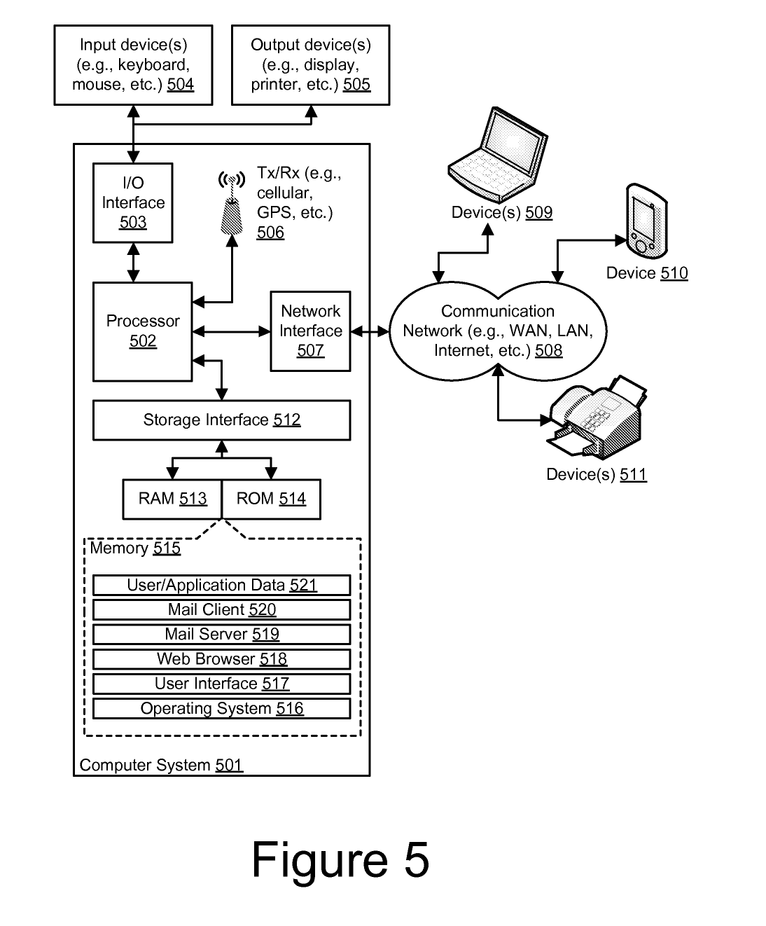

FIG. 5 is a block diagram of an exemplary computer system for implementing embodiments consistent with the present disclosure. Variations of computer system 501 may be used for implementing any of the devices presented in this disclosure. Computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 518-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 510, 511, and 512. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a method and a system for testing, of software applications, based on business process models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed:

1. A software application testing (SAT) system for testing a software application, based on at least one business process model, the SAT system comprising:
a processor;
a memory executable by the processor;
a data input module, executable by the processor, to receive the at least one business process model from a user, wherein the at least one business process model is indicative of at least one business process associated with the software application;
a test scenario identification module, executable by the processor, to analyze the at least one business process model to identify at least one test scenario;
a test case generation module, executable by the processor, to generate a set of test cases and test data for the at least one test scenario; and
a test script generation module, executable by the processor, to produce a set of test automation scripts based on one or more keywords associated with the at least one test scenario.

2. The SAT system as claimed in claim 1, wherein the test scenario identification module further:
parses the at least one business process model;
identifies the at least one distinct standalone business process from the parsed at least one business process model;
ascertains one or more start points of the at least one distinct standalone business process;
determines one or more path flows of the at least one distinct standalone business process from the ascertained one or more start points; and
identifies the at least one test scenario based on the one or more path flows.

3. The SAT system as claimed in claim 2, wherein the test scenario identification module further:
identifies a plurality of levels of testing from the parsed at least one business process model, wherein the plurality of levels comprise at least one of functional tests, system tests and system integration steps; and
links the at least one distinct standalone business process common to the plurality of levels of testing to identify the at least one test scenario.

4. The SAT system as claimed in claim 1, wherein the test case generation module further:
receives the test data from a user;
optimizes the received test data at an operational level based on the at least one test scenario; and
generates the set of test cases for the at least one test scenario.

5. The SAT system as claimed in claim 1, wherein the SAT system further comprises a change management module, coupled to the processor, to:
receive an updated business process model from the user, wherein the updated business process model corresponds to an updated business process associated with the software application;
parse the updated business process model;
compare the parsed updated business process model with a previous business model so as to generate a comparative snapshot of the impact of the changes due to the updated business process model;
analyze the comparative snapshot to identify the a test scenario which has been one of added, modified and deleted in the updated business process model; and
map the test cases and the test data to the one of added, modified and deleted test scenarios.

6. The SAT system as claimed in claim 1, wherein the SAT system further comprises a risk management module, coupled to the processor, to associate a risk index with the at least one test scenario based on the business criticality of the at least one test scenario, wherein the risk index is indicative of a priority of the at least one test scenario.

7. The SAT system as claimed in claim 1, wherein the SAT system further comprises a test suite output module, coupled to the processor, to:
format the test cases and the test scripts in a user-defined template; and
upload the test cases and the test scripts to at least one communicatively coupled test management tool for execution.

8. The SAT system as claimed in claim 1, wherein the SAT system further comprises a test suite output module, coupled to the processor, to:
fetch the test cases generated by the test case generation module;
map the test cases to pre-defined fields or place holders in a user-defined template; and
generate test automation scripts, based on keywords associated with the test cases and the user-defined template.

9. A computer implemented method of testing of a software application based on at least one business process model, the method comprising:
receiving, by a processor, the at least one business process model, wherein the at least one business process model is indicative of at least business process associated with the software application;
analyzing, by the processor, the at least one business process model to identify at least one test scenario;
generating, by the processor, a set of test cases and test data for the at least one test scenario; and
producing, by the processor, a set of test automation scripts based on one or more keywords associated with the at least one test scenario.

10. The method as claimed in claim 9, wherein the analyzing further comprises:
parsing, by the processor, the at least one business process model;
identifying, by the processor, at least one distinct standalone business process from the parsed at least one business process model;
ascertaining, by the processor, one or more start points of the at least one distinct standalone business process;
determining, by the processor, one or more path flows of the at least one distinct standalone business process from the ascertained one or more start points; and
identifying, by the processor, the at least one test scenario based on the one or more path flows.

11. The method as claimed in claim 10, wherein the analyzing further comprises:
identifying a plurality of levels of testing from the parsed at least one business process model, wherein the plurality of levels comprise at least one of functional tests, system tests and system integration steps; and
linking the at least one distinct standalone business process common to the plurality of levels of testing to identify the at least one test scenario.

12. The method as claimed in claim 9, wherein the generating further comprises:
receiving, by the processor, the test data from a user;
optimizing, by the processor, the received test data at an operational level based on the at least one test scenario; and
generating, by the processor, the set of test cases for the at least one test scenario.

13. The method as claimed in claim 9, wherein the method further comprises:
receiving, by the processor, an updated business process model from a user, wherein the updated business process model corresponds to an updated business process associated with the software application;
parsing, by the processor, the updated business process model;
comparing, by the processor, the parsed updated business process model with a previous business model so as to generate a comparative snapshot of the impact of the changes due to the updated business process model;
analyzing, by the processor, the comparative snapshot to identify the a test scenario which has been one of added, modified and deleted in the updated business process model; and
mapping, by the processor, the test cases and the test data to the one of added, modified and deleted test scenarios.

14. The method as claimed in claim 9, wherein the method further comprises:
associating, by the processor, a risk index with the at least one test scenario based on the business criticality of the at least one test scenario, wherein the risk index is indicative of the criticality and the priority of the at least one test scenario; and
executing, by the processor, the test cases associated with the at least one test scenario in an order based on the risk index.

15. The method as claimed in claim 9, wherein the method further comprises:
formatting, by the processor, the test cases and the test scripts in a user-defined template; and
uploading, by the processor, the test cases and the test scripts, to at least one communicatively coupled test management tool, for execution.

16. The method as claimed in claim 9, wherein the method further comprises:
fetching, by the processor, the test cases generated by the test case generation module;
mapping, by the processor, the test cases to pre-defined fields or place holders in a user-defined template; and
generating, by the processor, test automation scripts, based on keywords associated with the test cases and the user-defined template.

17. A non-transitory computer readable medium comprising a set of computer executable instructions, which, when executed on a computing system causes the computing system to perform the steps of:
receiving the at least one business process model, wherein the at least one business process model is indicative of a business process associated with the software application;
analyzing the at least one business process model to identify at least one test scenario;
generating a set of test cases and test data for the at least one test scenario; and
producing a set of test automation scripts based on one or more keywords associated with the at least one test scenario.

18. The non-transitory computer readable medium as claimed in claim 17, wherein the set of computer executable instructions, which, when executed on the computing system causes the computing system to further perform the steps of:
parsing, by the processor, the at least one business process model;
identifying at least one distinct standalone business process from the parsed at least one business process model;
ascertaining one or more start points of the at least one distinct standalone business process;
determining one or more path flows of the at least one distinct standalone business process from the ascertained one or more start points; and
identifying the at least one test scenario based on the one or more path flows.

19. The non-transitory computer readable medium as claimed in claim 17, wherein the set of computer executable instructions, which, when executed on the computing system causes the computing system to further perform the steps of:
receiving an updated business process model from a user, wherein the updated business process model corresponds to an updated business process associated with the software application;
parsing the updated business process model;
comparing the parsed updated business process model with a previous business model so as to generate a comparative snapshot of the impact of the changes due to the updated business process model;
analyzing the comparative snapshot to identify the a test scenario which has been one of added, modified and deleted in the updated business process model; and
mapping the test cases and the test data to the one of added, modified and deleted test scenarios.

20. The non-transitory computer readable medium as claimed in claim 17, wherein the set of computer executable instructions, which, when executed on the computing system causes the computing system to further perform the steps of:
associating a risk index with the at least one test scenario based on the business criticality of the at least one test scenario, wherein the risk index is indicative of the criticality and the priority of the at least one test scenario; and
executing the test cases associated with the at least one test scenario in an order based on the risk index.
